(19) United States
(12) Patent Application Publication
(10) Pub. No.: US 2024/0312363 A1
(43) Pub. Date: Sep. 19, 2024

(54) METHOD AND SYSTEM TO USE STUDENT ACADEMICS TO FORM A SIMULATED CREDIT SCORE

(71) Applicant: Willie B. Rollins, Winter Haven, FL (US)

(72) Inventor: Willie B. Rollins, Winter Haven, FL (US)

(21) Appl. No.: 18/494,766

(22) Filed: Oct. 25, 2023

Related U.S. Application Data
(60) Provisional application No. 63/419,301, filed on Oct. 25, 2022.

(51) Int. Cl. G09B 19/00; G06Q 50/20

(52) U.S. Cl. CPC G09B 19/00; G06Q 50/2053

(57) ABSTRACT

Methods, systems and computer readable media to generate and maintain academic credit scores for financial education and financial literacy education are described.

### TECHNICAL FIELD

Embodiments relate generally to computer-based educational methods and systems, and more particularly, to methods, systems and computer readable media to use student academics to generate a simulated credit score in order to help teach financial concepts including credit.

### BACKGROUND

According to the National Center for Education Statistics, only about 30% of college graduates immediately enter the workforce upon completion. So, for the other 70% seeking higher education, credit score classes or classes pertaining to personal finance are very few.

Regardless these graduates will need to have been equipped with the necessary tools needed to make smart financial decisions such as how to build/establish credit. Because of this high school seems to be the best time to introduce students to credit and how it works.

### SUMMARY

M.A.C.S. will start out as a web-based program where teachers/parents will be able to input information about a student, and through our algorithm generate a credit score. Students will be able to login to our site in order to check their score and keep track of their process. By participating in our program students will be able to earn different items from our store provided by the school as they reach different levels. Also, students will have the opportunity to earn scholarships in the amount of their credit score.

### BRIEF DESCRIPTION OF THE DRAWINGS

FIG. 1 is a flowchart showing an example method of using student academics to generate a simulated credit score in order to help teach financial concepts including credit in accordance with some implementations.

FIG. 2 is a flowchart showing an example method of using student academics to generate a simulated credit score in order to help teach financial concepts including credit in accordance with some implementations.

FIG. 3 is a diagram of an example computing device configured for using student academics to generate a simulated credit score in order to help teach financial concepts including credit in accordance with at least one implementation.

### DETAILED DESCRIPTION

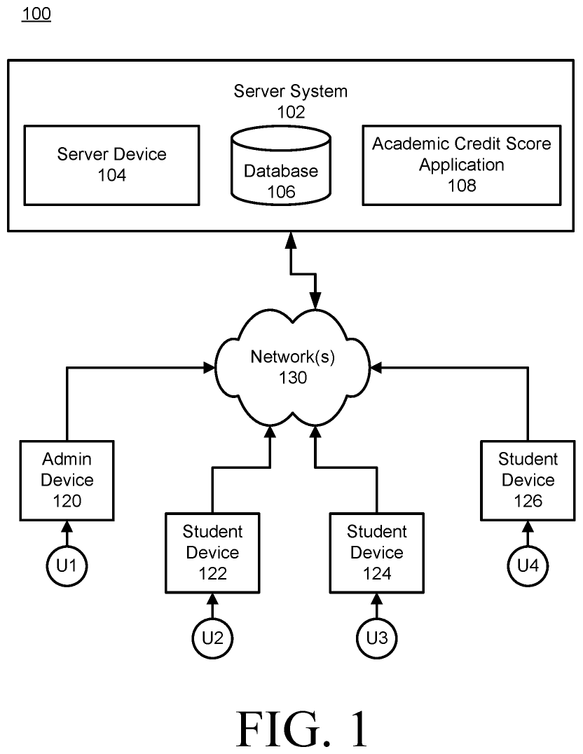

FIG. 1 is a flowchart showing an example method of using student academics to generate a simulated credit score in order to help teach financial concepts including credit in accordance with some implementations. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and an academic credit score application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide academic credit score functions.

Various implementations of features described herein can use any type of system and/or service. Any type of electronic device can make use of the features described herein. Some implementations can provide one or more features described herein on client or server devices disconnected from or intermittently connected to computer networks.

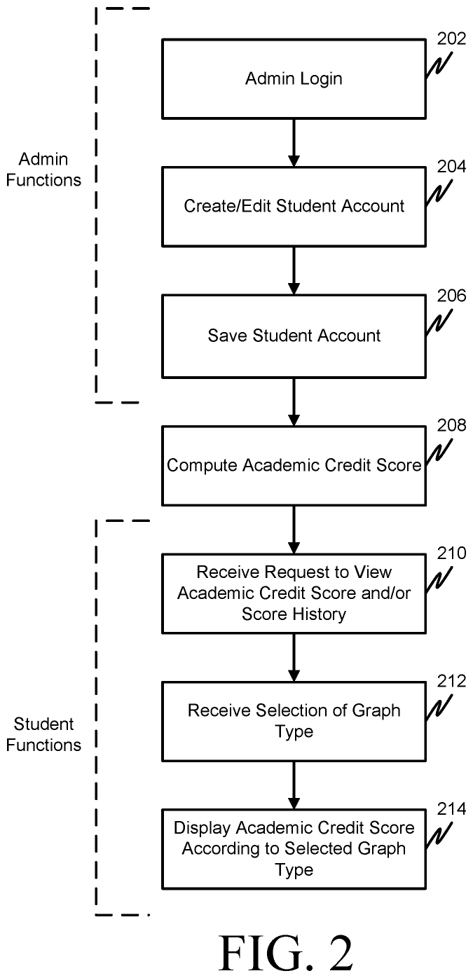

FIG. 2 is a flowchart showing an example method of using student academics to generate a simulated credit score in order to help teach financial concepts including credit in accordance with some implementations. Processing begins at 202, where an administrator logs in or creates an account. Processing continues to 204.

At 204, a student account is created and/or edited by an administrator or authorized administrative user. Processing continues to 206.

At 206, the student account Some implementations can include saved in a computer memory or storage device. Processing continues to 208.

At 208, an academic credit score is computed. The academic information for students can be obtained from another system (when the academic credit score system is a separate system or in process) or the same system if the academic credit score system/process is integrated with an academic system. The academic credit score can be computed based on one factor or a combination of factors associated with the student. For example, the factors can include a value based on: assignments assigned and turned in, assignments assigned and not turned in, days of school and days attended, days of school and days attended, credits required to graduate and credits completed, a value based on one or more class grades (e.g., individual class grades for a grading period, a current point in the school year, a semester, or the like), and/or one or more values based on other factors such as community service hours, awards, honors, recognitions, disciplinary actions, etc.

The values can be scaled or weighted in order to produce a single value:

For example, a formula for a scaled single value can include:

$$= ( E 3 * 1.485 ) + ( F 3 * - 1.485 ) + ( J 3 * 0.635 ) + ( K 3 * - 0.635 ) + ( N 3 + 1.7 ) + ( U 3 * 2.55 )$$

Where E3 represents a percentage of assignments turned in;
F3 represents a percentage of assignments not turned in;
J3 represents a percentage of days attended;
K3 represents a percentage of days not attended;
N3 represents a percentage of graduation credits needed completed; and
U3 represents a grade average. The numerical scale factors are examples and can vary based on a contemplated implementation. Processing continues to 210.

At 210, a request to view the academic credit score and/or academic credit score history is received (e.g., from a student). Processing continues to 212.

At 212, a selection of a graph type is optionally received. The graph types can include a line graph, or other types of plot or graph. Processing continues to 214.

At 214, the academic credit score and/or graph is caused to be displayed on the student device.

One or more steps can be repeated to update the academic credit scores for one or more students.

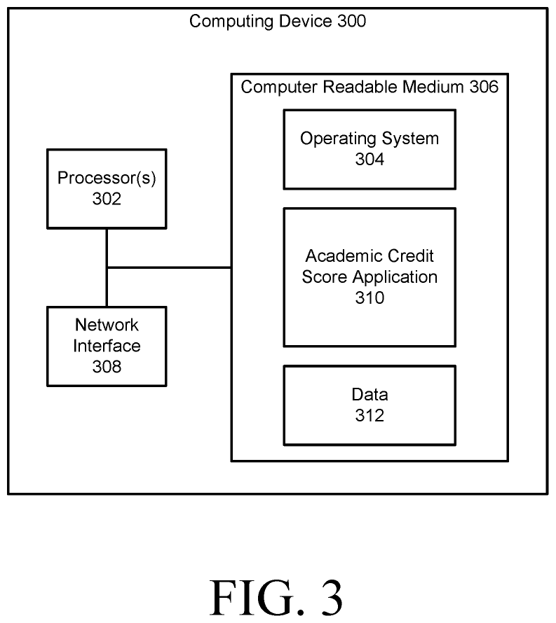

FIG. 3 is a diagram of an example computing device 300 in accordance with at least one implementation. The computing device 300 includes one or more processors 302, nontransitory computer readable medium 306 and network interface 308. The computer readable medium 306 can include an operating system 304, an application 310 for academic credit scores and a data section 312 (e.g., for storing student accounts, student academic credit score values such as those discussed above at 208, scale factors or weighting factors, etc.).

In operation, the processor 302 may execute the application 310 stored in the computer readable medium 306. The application 310 can include software instructions that, when executed by the processor, cause the processor to perform operations to perform academic credit score functions in accordance with the present disclosure (e.g., performing associated functions described above and shown in FIG. 2).

The application program 310 can operate in conjunction with the data section 312 and the operating system 304.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to generate and provide an academic credit score for education purposes.

While the disclosed subject matter has been described in conjunction with a number of embodiments, it is evident that many alternatives, modifications and variations would be, or are, apparent to those of ordinary skill in the applicable arts. Accordingly, Applicant intend to embrace all such alternatives, modifications, equivalents and variations that are within the spirit and scope of the disclosed subject matter.

What is claimed is:

1. A computer implemented method comprising:
receiving an administrator login or account creation;
creating a student account;
saving the student account in a computer memory or storage device;
computing an academic credit score;
receiving a request to view the academic credit score and/or academic credit score history; and
displaying the academic credit score.
